(19) United States
(12) Patent Application Publication
(10) Pub. No.: US 2008/0216757 A1
(43) Pub. Date: Sep. 11, 2008

(54) Breeding tank

(76) Inventor: Kuo-Tang Tseng, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 11/715,474

(22) Filed: Mar. 8, 2007

(51) Int. Cl. A01K 61/00

(52) U.S. Cl. 119/206; 119/218

(57) ABSTRACT

A breeding tank comprising at least two dish-like breeding tubs each having a breeding space and each having a tub bottom and an opening surrounded by a periphery of a top of each of the dish-like breeding tubs, the tub bottoms of all the dish-like breeding tubs are arranged in a mutually vertically stacking mode, and the opening of each lower dish-like breeding tub is larger than that of its-upper dish-like breeding tub, all the dish-like breeding tubs are made of transparent material except the lowermost dish-like breeding tub. The present invention thus can make multiple vertically stacking breeding spaces in a limited space for breeding aquatic animals such as fishes, shrimps and crustacea etc.

### BACKGROUND OF THE INVENTION

1. Field of the Invention

The present invention relates to an aquaculture technique, and especially to an aquaculture technique that can make multiple vertically stacking breeding spaces in a limited space, each breeding space has a shadow zone and a bright zone for respectively resting and wandering about of aquatic animals such as fishes, shrimps and crustacea etc.

2. Description of the Prior Art

Conventional art of aquatic animal breeding had been affected by the factors including environment, water source, viruses etc. its yield of products had fallen down since years ago, hence many providers studied various things in relating to breeding of the aquatic animals to expect that yield of the products of aquatic animals can be increased in most limited spaces.

Taking the art of shrimp breeding as an example, the most often seen measure of the prior art is to provide nets with racks in a limited space to divide the space into multiple vertically stacking breeding spaces in 3 dimensions, thereby the gross area for resting of the animals is increased; as for shrimps, their effective resting space is increased, and thus the yield of the products of shrimps can be increased too.

However, although the prior art can increase the gross area for resting, it is subjected to having the following problems:
1. By the fact that the nets with racks are designed to be mutually stacked vertically, the lower breeding spaces will have the problem of insufficient light penetration.
2. By the fact that the nets with racks are designed to be mutually stacked vertically, the bait cast in during feeding will be snatched by a folk of shrimps in the upper breeding spaces, only the remaining bait falls into the lower breeding spaces; this results a situation of non-uniform bait casting that make the upper breeding spaces get more bait, and the lower breeding spaces get insufficient bait.
3. By the fact that the nets with racks are designed to be mutually stacked vertically, the excretions of the folk-of shrimps will precipitate downwards to affect the environment of the lower breeding spaces for the folk of shrimps.

Moreover, the inventor of the present invention observed and studied for a long period that the viewing organ of a shrimp includes a pair of compound eyes, thereby the color variation reflected from light of the circumstance is very sensible for the shrimp; plus the influence of the instinct of having protection colors of living things, if shrimps are placed at an environment being closer to dark, excitation phenomenon and wandering action will be evidently reduced, hence shrimps being fully fed can quietly rest; on the contrary, if shrimps are placed at an environment having brighter light, excitation phenomenon and wandering action will be evidently increased.

Therefore, if darkness and brightness of light beams in the field of breeding can be controlled to suitably create an environment suitable for wandering about of shrimps to find foods and to rest calmly, unnecessary excitation phenomenon and wandering action will be evidently reduced, and shrimps being fully fed can quietly rest, and mutual eating among the shrimps themselves can be avoided to the smallest degree, thereby the shrimps can grow stably and fast.

In view of the above stated problems in conventional techniques, the inventor of the present invention provides a kind of breeding tank after study and development on the 3 dimensional breeding technique, thus the problems in the conventional 3 dimensional breeding technique can be solved, and the novel technique can be applied widely in breeding aquatic animals such as fishes, shrimps and crustacea etc. to increase the yield of production.

### SUMMARY OF THE INVENTION

As to the main technical measure, a breeding tank of the present invention comprises at least two dish-like breeding tubs which each has a tub bottom and an opening surrounded by a periphery of a top of the dish-like breeding tub, the tub bottoms of all the dish-like breeding tubs are arranged in a mutually vertically stacking mode, and the opening of each lower dish-like breeding tub is larger than that of its upper dish-like breeding tub, all the dish-like breeding tubs are made of transparent material except the lowermost dish-like breeding tub.

Secondly, the breeding tank of the present invention further comprises a dirt discharging tube and a light obscuring plate, each dish-like breeding tub has on its bottom a vertically extending through hole; the dirt discharging tube is vertically extended through the through holes of all the dish-like breeding tubs, and the dirt discharging tube has for every breeding space a dirt discharging hole; the light obscuring plate is provided at a position near the water surface of the uppermost dish-like breeding tub in a mode of drifting or in some other fixing mode, so that a zone of the bottom of every dish-like breeding tub under the light obscuring plate presents as a shadow zone for resting of shrimps, while the bright zone outside of the shadow zone is provided for wandering about of the shrimps.

The above stated bottom of every dish-like breeding tub can be made to render its outer edge higher, and to render its area near its through hole lower to thereby form an inclined state in favor of discharging dirt. And all the dish-like breeding tubs can be made of transparent material for aeration (such as soft rubber) or of transparent hard material (such as acryl), the dish-like breeding tubs can float in the water.

And more, the opening of each lower dish-like breeding tub is larger than that of its upper dish-like breeding tub, the depth of the breeding space of any lower dish-like breeding tub is larger than that of the breeding space of its upper dish-like breeding tub; all the openings of the dish-like breeding tubs are extended up to the same level, so that every two neighboring openings form therebetween a channel for casting bait, i.e., every breeding space can be used independently for casting bait.

Moreover, the surface of every tub bottom is provided with a color painting layer with a shape in coincidence with that of the light obscuring plate to evidently present the shadow zones; and the color painting layers can be in white color in practicing for the custom of specific kind of shrimp.

Further, every tub bottom is provided at least with a netted zone with mesh holes for water to flow down the tub bottom, so that the water flowing effect in the breeding spaces can be better; and the surface of each netted zone with mesh holes is relieved to increase the effective filtering area of the netted zones, thereby dirt in the water flow can be more easily collected for being discharged.

The present invention will be apparent after reading the detailed description of the technical measure of the preferred embodiment thereof in reference to the accompanying drawings.

### BRIEF DESCRIPTION OF THE DRAWINGS

FIG. 1 is a sectional schematic view of a first embodiment of the present invention;

FIG. 2 is an anatomic perspective view of the first embodiment of the present invention;

FIG. 3 is a schematic sectional view of a second embodiment of the present invention;

FIG. 4 is a schematic perspective view of a third embodiment of the present invention.

### DETAILED DESCRIPTION OF THE PREFERRED EMBODIMENT

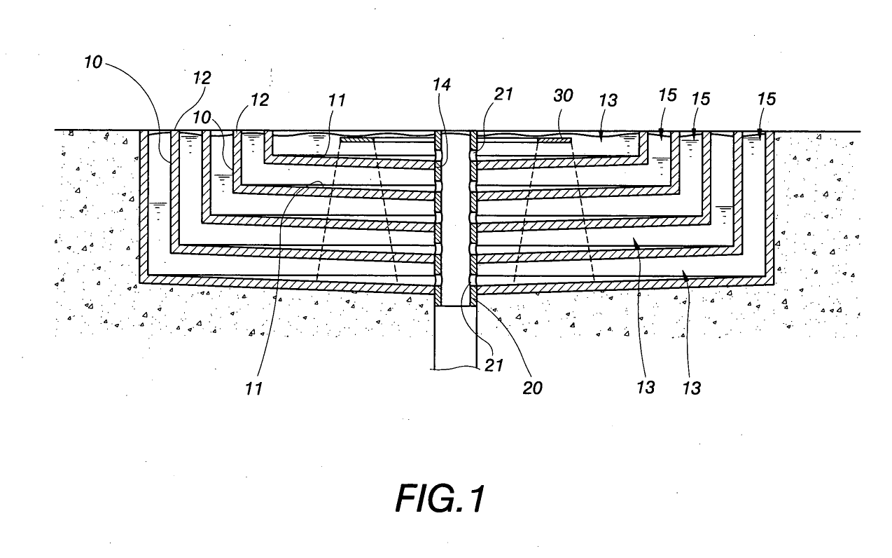

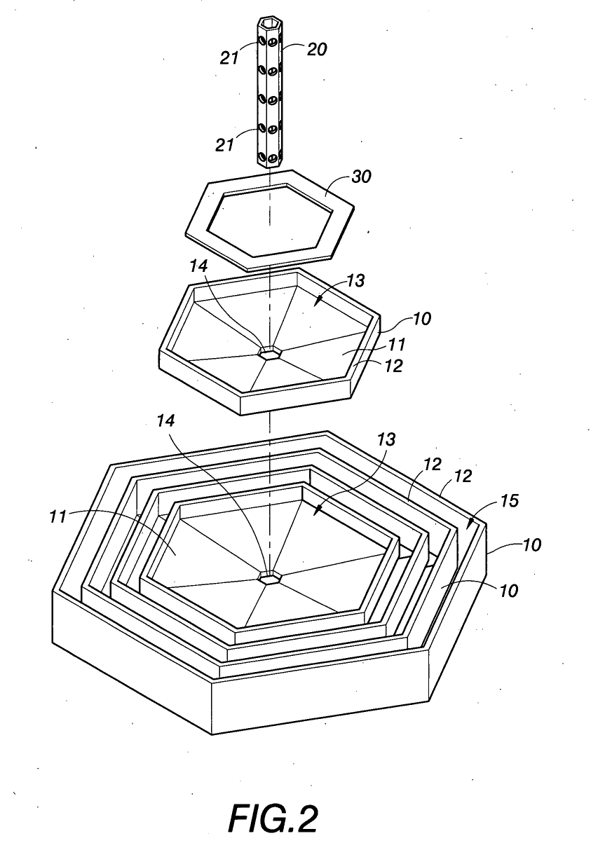

Referring firstly to FIGS. 1 and 2, wherein FIG. 1 is a sectional schematic view of a first embodiment of the present invention, and FIG. 2 is an anatomic perspective view of the first embodiment of the present invention; the drawings show that a breeding tank can be embedded in ground or in artificial concrete, the breeding tank comprises at least two dish-like breeding tubs 10, a dirt discharging tube 20 and a light obscuring plate 30.

All the dish-like breeding tubs 10 can be made of transparent material except the lowermost dish-like breeding tub 10. Each dish-like breeding tub 10 has a tub bottom 11 and an opening 12 surrounded by a periphery of the top the dish-like breeding tub 10, thus the tub bottom 11 and the opening 12 form therebetween a breeding space 13 in the shape of a dish, the dish-like breeding tub 10 is in the shape of a circle in practicing, and can be polygonal as shown in the drawings (such as hexagonal). The tub bottoms 11 of all the dish-like breeding tubs 10 are arranged in a mutually vertically stacking mode, and the tub bottom 11 of each dish-like breeding tub 10 has a vertically extending through hole 14. And the opening 12 of each lower dish-like breeding tub 10 is larger than that of its upper dish-like breeding tub 10. The depth of the breeding space 13 of any lower dish-like breeding tub 10 is larger than that of the breeding space 13 of its upper dish-like breeding tub 10; all the openings 12 of the dish-like breeding tubs 10 are extended up to the same level, so that every two neighboring openings 12 form therebetween a channel 15 for casting bait, i.e., every breeding space 13 can be used independently for casting bait. And all the dish-like breeding tubs 10 in this embodiment can be made of transparent hard material (such as acryl), the dish-like breeding tubs 10 can float in the water and present high transparency.

The above mentioned dirt discharging tube 20 is vertically extended through the through holes 14 of all the dish-like breeding tubs 10, and the dirt discharging tube 20 has for every breeding space 13 a dirt discharging hole 21; the above stated tub bottom 11 of every dish-like breeding tub 10 can be made to render its outer edge higher, and to render its area near its through hole 14 lower to thereby form an inclined state in favor of discharging dirt created in breeding out of the dirt discharging hole 21 more smoothly.

The above mentioned light obscuring plate 30 is provided at a position near the water surface of the uppermost dish-like breeding tub 10 in a mode of drifting so that a zone of the tub bottom 11 of every dish-like breeding tub 10 under the light obscuring plate 30 presents as a shadow zone; certainly, the light obscuring plate 30 can also be mounted at a position near the water surface of the uppermost dish-like breeding tub 10 by using brackets or in some other fixing mode with the same effect of mounting.

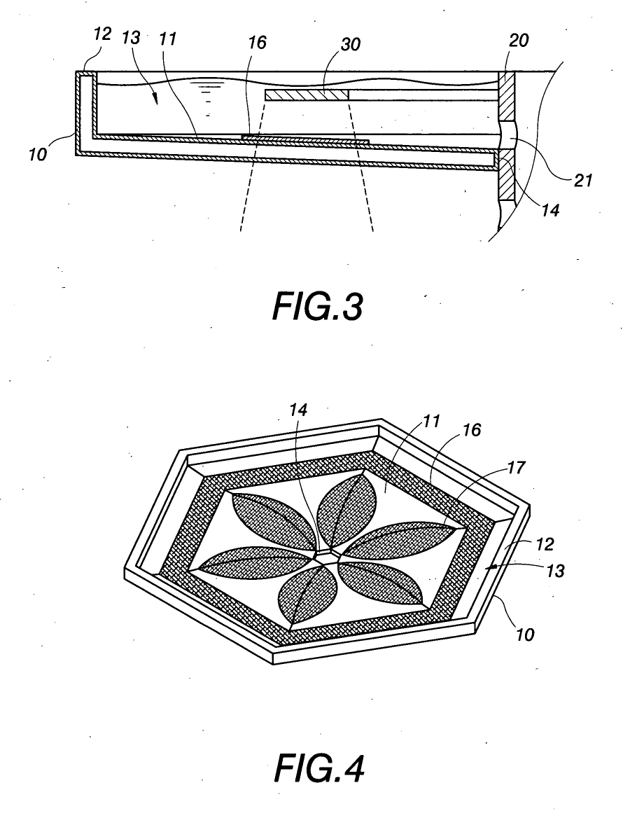

As shown in FIG. 3 showing a schematic sectional view of a second embodiment of the present invention, in this embodiment, all the dish-like breeding tubs 10 can be made of transparent material for aeration (such as soft rubber), and the dish-like breeding tubs can float in the water too and present high transparency. Moreover, the surface of every tub bottom 11 is provided with a color painting layer 16 with a shape in coincidence with that of the light obscuring plate 30 to evidently present the shadow zones; and the color painting layers 16 can be in white color in practicing for the custom of specific kind of shrimp.

As shown in FIG. 4 showing a schematic sectional view of a third embodiment of the present invention, every tub bottom 11 is provided at least with a netted zone 17 with mesh holes for water to flow down the tub bottom 11, so that the water flowing effect in the breeding spaces 13 formed by the dish-like breeding tubs 10 can be better; and the surface of each netted zone 17 with mesh holes is relieved to increase the effective filtering area of the netted zones 17, thereby dirt in the water flow can be more easily collected for being discharged.

The embodiment stated and depicted above is only for illustrating the present invention and not for giving any limitation to the scope of the present invention, it will be apparent to those skilled in this art that various equivalent modification's or changes without departing from the object and spirit of this invention shall also fall within the scope of the appended claims.

1. A breeding tank comprising:
at least two dish-like breeding tubs each having a breeding space and each having a tub bottom and an opening surrounded by a periphery of a top of each of said dish-like breeding tubs, said tub bottoms of all said dish-like breeding tubs are arranged in a mutually vertically stacking mode, and one of said openings of any lower one of said dish-like breeding tubs is larger than that of one of said dish-like breeding tubs just provided thereabove, all said dish-like breeding tubs are made of transparent material except a lowermost one of said dish-like breeding tubs.

2. The breeding tank as in claim 1, wherein said breeding tank further comprises a dirt discharging tube and a light obscuring plate, each of said dish-like breeding tubs has on one of said tub bottoms of it a vertically extending through hole; said dirt discharging tube is vertically extended through said through holes of all said dish-like breeding tubs, and said dirt discharging tube has for every one of said breeding spaces a dirt discharging hole; said light obscuring plate is provided at a position near a water surface of an uppermost one of said dish-like breeding tubs in a mode of drifting so that a zone of said tub bottom of every one of said dish-like breeding tubs under said light obscuring plate presents as a shadow zone.

3. The breeding tank as in claim 2, wherein said tub bottom of each of said dish-like breeding tubs is made to render its outer edge higher, and to render an area thereof near said through hole thereof lower to thereby form an inclined state.

4. The breeding tank as in claim 1, wherein all said dish-like breeding tubs are made of transparent material for aeration.

5. The breeding tank as in claim 1, wherein all said dish-like breeding tubs are made of transparent hard material.

6. The breeding tank as in claim 1, wherein depth of one of said breeding spaces of any lower one of said dish-like breeding tubs is larger than that of one of said dish-like breeding tubs just provided thereabove, all said openings of said dish-like breeding tubs are extended up to same level, so that every two neighboring ones of said openings form therebetween a channel for casting bait.

7. The breeding tank as in claim 2, wherein a surface of each of said tub bottoms is provided with a color painting layer with a shape in coincidence with that of said light obscuring plate.

8. The breeding tank as in claim 7, wherein said color painting layer is in white color.

9. The breeding tank as in claim 1, wherein each of said tub bottoms is provided at least with a netted zone with mesh holes for water to flow down said tub bottom.

10. The breeding tank as in claim 9, wherein a surface of each of said netted zones with mesh holes is relieved.
